(19) United States
(12) Patent Application Publication
(10) Pub. No.: US 2006/0090200 A1
(43) Pub. Date: Apr. 27, 2006

(54) Computer, computer security setting method, and program

(75) Inventor: Masaki Oie, Tokyo (JP)

Correspondence Address: IBM CORPORATION, PO BOX 12195, DEPT YXSA, BLDG 002, RESEARCH TRIANGLE PARK, NC, 27709, US

(73) Assignee: INTERNATIONAL BUSINESS MACHINES CORP, ARMONK, NY (US)

(21) Appl. No.: 10/510,913

(22) PCT Filed: Apr. 7, 2003
(86) PCT No.: PCT/JP03/04419

§ 371 Date: Oct. 19, 2005

(30) Foreign Application Priority Data
Apr. 11, 2002 (JP) 2002-109714

(51) Int. Cl. G06K 9/00

(52) U.S. Cl. 726/7

(57) ABSTRACT

A technique for reliably changing settings according to the usage environment to increasingly ensure a high-security network connection environment. A PC judges the usage environment of the PC by searching for addresses of nearby devices such as Bluetooth devices and, depending on the usage environment, automatically changes the security level setting. Even when the PC is in a usage environment in which the security level should be “home” or “office” but any devices that should be in that usage environment are not detected during usage environment judgment processing, the level is set to the “mobile” security level at which high security is ensured.

### BACKGROUND OF THE INVENTION

1. Technical Field

The present invention relates to a portable computer apparatus and a technology suitable for controlling settings such as security settings.

2. Background Art

Today, portable “mobile devices” such as notebook PCs and PDA (Personal Digital Assistants) are widely used.

A user of a notebook PC (hereinafter simply referred to as a PC) connected to a network through a wireless LAN at his or her office, for example, may take the PC home and connects it to a network through a modem and an analog telephone line or connect it to the network on the go through his or her cellphone.

Recently, wireless LAN environments have been provided in certain areas in stations and business quarters. In such areas, one can connect to a network over the wireless LAN provided.

Furthermore, short-range wireless communication technologies such as Bluetooth are becoming widespread. One can use Bluetooth to carry out data communications at his or her office, home, and on the go with a LAN access point or another device through a modem.

When a PC is used in different environments, such as an office, home, on the go (hereinafter referred to as “mobile” as appropriate), the user must change settings on the PC at least for connecting it to a network each time he or she carries it into a different environment.

The setting change is obviously cumbersome because several to several dozens of settings must be changed and, if the changes are incorrect, the PC cannot be connected to the network.

To solve these problems, an arrangement is provided in some PCs that allows settings on them to be changed by the simple operation of selecting a using environment in a utility displayed on a taskbar or the like. Once setting for each of the environments has been made, it is not necessary to make complicated setting each time the PC is used in a different environment.

However, if the user selects wrong setting such as selecting setting for home at his or her office, for example, network connection failure arises. Furthermore, even if the PC can be connected to the network, another serious problem may occur: if the user is actually on the road, where a higher security level for a “mobile” environment should be set, and still uses the PC with a lower level security setting for “home”, potential security hole may result.

If the security hole exists, unauthorized access from an other's device cannot effectively be prevented especially in an environment where a wireless LAN or Bluetooth is used to connect to the network.

The present invention has been made to solve these technical problems. A purpose of the present invention is to provide a technology that can ensure that setting changes are made according to an environment.

Another purpose of the present invention is to ensure that a higher-level security network-connection environment is always provided.

### SUMMARY OF THE INVENTION

For the above-mentioned purposes, in a computer apparatus of the present invention, a means for determining environment determines an environment under which the computer apparatus is located based on identification information of another device acquired by a means for acquiring identification information by communicating with other device. Then based on the determined environment, a means for selecting a setting of the computer apparatus modifies a setting of the computer apparatus such as a security setting.

At this time, the means for determining environment can determine the environment under which the computer apparatus is located by identifying other device existing in periphery of the computer apparatus based on identification information.

Further, when the computer apparatus is equipped with a communication means for performing Bluetooth communication, the acquisition means can obtain a Bluetooth device address allotted individually to devices being capable of Bluetooth communication from the other device as identification information.

Here, it is preferable that when the determination is that the computer apparatus is under a specific environment such as home or office, the selecting means selects a security setting corresponding to the determined environment, and when the determination is that the computer apparatus is not in the prescribed environment such as outside of the periphery of a site, the selecting means selects a security setting with a higher security than that under the presecibed environment.

Further, the selecting means can also modify a setting of control over electricity consumption in the computer apparatus based on the environment under which the computer apparatus is located.

In a method for selecting security setting of a computer of the present invention, information about an environment under which the computer apparatus is located is acquired and security setting on the computer apparatus is selected on the basis of the acquired information.

The information about the environment can be obtained from identification information about devices in the vicinity of the computer apparatus that is transferred from the devices. Alternatively, the information about the environment of the computer apparatus may be obtained as position information from GPS (Global Positioning System) if the computer apparatus can use GPS.

Furthermore, the level of the security can be selected according to whether or not identification information about the devices is registered. If identification information about the device is not registered, the security level may be selected to a level higher than the current level.

In another aspect, the present invention can be viewed as a method for selecting security setting of a computer. The method comprises the steps of acquiring device information about a device capable of communicating with the computer apparatus, receiving from an external source an input for specifying security setting for an environment where the device information can be acquired, and associating and storing the specified security setting with the device information.

In this method, after the security setting and the device information is stored, device information about a device capable of communicating with the computer apparatus is acquired, security information associated with the acquired device information is invoked, and switching to the invoked security information is made.

In another aspect, the present invention can be viewed as a program for causing a computer apparatus to perform a predetermined process. The program comprises the steps of acquiring address information about devices through Bluetooth-based communication with those devices, and selecting the security setting and other settings on the computer apparatus on the basis of the acquired address information.

The computer apparatus according to the present invention is not limited to a PC. It may of course be PDA, a cellphone, or any of various other devices.

### BRIEF DESCRIPTION of the DRAWINGS

Some of the purposes of the invention having been stated, others will appear as the description proceeds, when taken in connection with the accompanying drawings, in which:

FIG. 1 shows a configuration of a computer apparatus according to the present embodiment of the present invention;

FIG. 2 shows a configuration of a portion of the computer apparatus that involves in setting control with Bluetooth;

FIG. 3 shows an example of the environment of the computer apparatus for which the security level “home” is to be set;

FIG. 4 shows an example of the environment of the computer apparatus for which the security level “office” is to be set;

FIG. 5 shows an example of the environment of the computer apparatus for which the security level “mobile” is to be set;

FIG. 6 shows an example of a number of levels security settings;

FIG. 7 shows a process flow for setting initial security values; and

FIG. 8 shows a process flow for changing security settings according to environments in which the PC is used.

### DETAILED DESCRIPTION of the ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Referring now more particularly to the accompanying drawings, in which like numerals indicate like elements or steps throughout the several views, a best mode for carrying out the invention will be described.

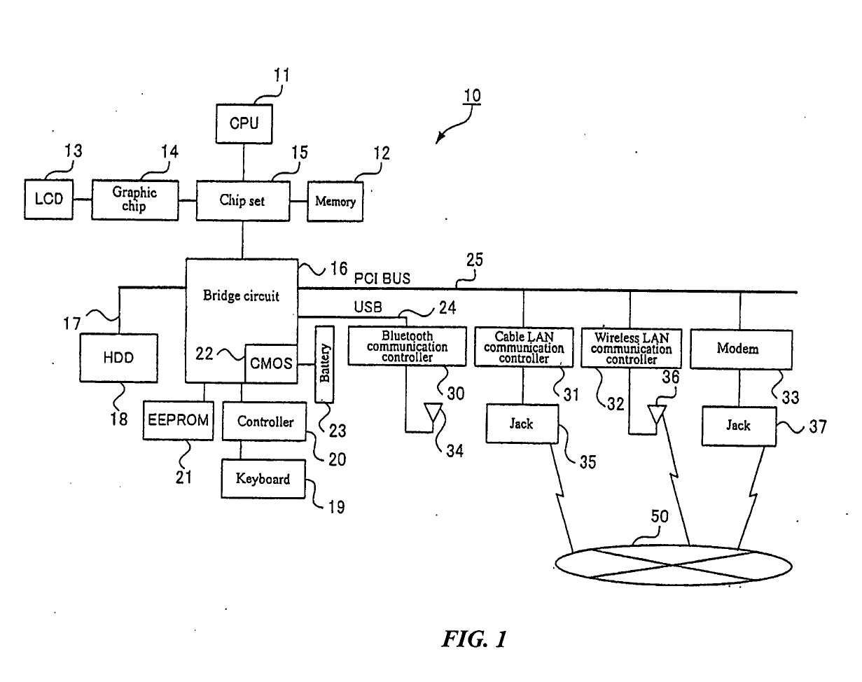

FIG. 1 is a diagram for explaining a device configuration of a notebook PC (computer apparatus) 10 according to the embodiment.

As shown in FIG. 1, the PC 10 comprises a CPU 11 for performing processes based on a given control program, a memory 12 such as a RAM (Random Access Memory) for storing data to be processed, and a graphic chip 14 for controlling images displayed on a display unit (LCD) 13, which are all connected to a chip set 15.

The chip set 15 is connected to a bridge circuit 16. An HDD 18 is connected to the bridge circuit 16 through an IDE channel 17. Also connected to the bridge circuit 16 are a controller 20, which outputs events based on signals input from a pointing device such a keyboard 19 and mouse (not shown), and an EEPROM (Electrically Erasable and Programmable ROM) 21 storing BIOS (Basic Input/Output System). The BIOS controls components of the PC 10 according to inputs from the keyboard 19 and pointing device.

The bridge circuit 16 contains a CMOS (Complementary Metal Oxide Semiconductor) 22 for storing various settings. The CMOS 22 is continuously provided with power by a battery 23.

Also connected to the bridge circuit 16 are a Bluetooth communication controller (identification information acquisition means, communication means) 30 through a USB (Universal Serial Bus) 24, a cable LAN communication controller 31, a wireless LAN communication controller 32, and a modem 33 through a PCI (Peripheral Component Interconnect) bus 25.

The Bluetooth communication controller 30 controls short-range wireless data communication with another Bluetooth-capable device through an antenna 34. The Bluetooth communication controller 30 controls communication with a Bluetooth-capable device within a range (typically 10 to 100 m) that a radio wave received and sent through the antenna 34 reaches. The Bluetooth-capable device emits a radio wave including Bluetooth device address (hereinafter referred to as a BD address) while power is being supplied to it. The Bluetooth communication controller 30 has the capability of detecting a BD address included in a radio wave received through the antenna 34.

The cable LAN communication controller 31 accesses an external network 50 through a LAN cable (not shown) connected to its jack 35 to control data communication with another computer apparatus over the network 50.

The wireless LAN communication controller 32 accesses the external network 50 through an antenna 36 to control data communication with another computer apparatus over the network 50.

The modem 33 accesses the network 50 through a cable (not shown) connected to its jack 37 over an analog network to control data communication with another computer apparatus over the network 50.

Thus, the PC 10 can connect to the network through any of the Bluetooth, the wireless LAN, the cable LAN, and the analog telephone network.

The cable LAN communication controller 31 and the wireless LAN communication controller 32 may be actually implemented as a single Ethernet chip. Not all of the Bluetooth communication controller 30, the cable LAN communication controller 31, the wireless LAN communication controller 32, and the modem 33 are mandatory. Network communication capabilities can be provided through the provision of the Bluetooth communication controller 30 alone. If none of the cable LAN communication controller 31, the wireless LAN communication controller 32, and the modem 33 are provided, the PC 10 can use the Bluetooth communication controller 30 to access a LAN access point through short-range wireless communication and, from the LAN access point, access the network 50.

The PC 10 configured as described above uses the Bluetooth communication controller's 30 capability of recognizing devices in a range that the radio wave from the PC 10 reaches to determine the environment of the PC 10 on the basis of the type or other factors of the devices in its vicinity. The PC 10 automatically makes security and other settings according to that environment.

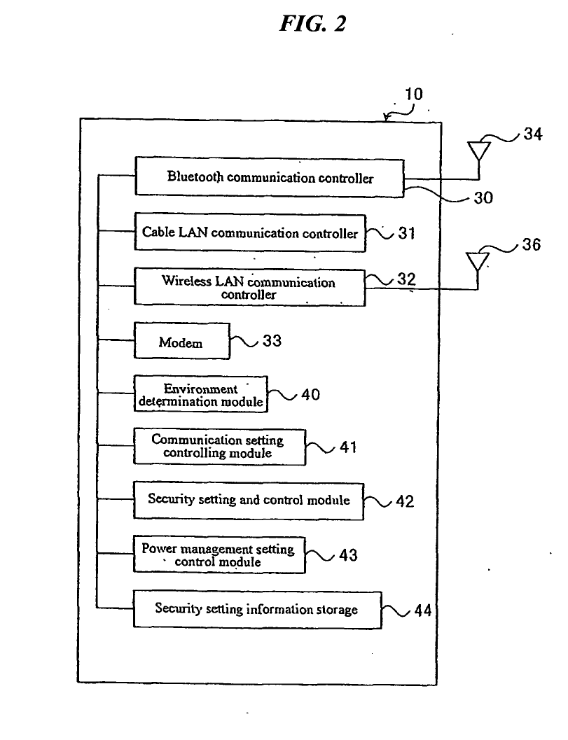

FIG. 2 shows a functional configuration of the PC 10 having the device configuration as described above. As shown in FIG. 2, the PC 10 has an environment determination module (using environment determination means) 40, a communication setting control module 41, security setting control module (setting modification means) 42, and a power management setting control module (setting modification means) 43, which are functions implemented by the CPU (not shown) performing processes based on programs preinstalled.

The environment determination module 40 collects information about Bluetooth-capable devices through the Bluetooth communication controller 30 to determine the environment of the PC 10.

The communication setting control module 41 makes network communication settings according to the environment determined by the environment determination module 40.

The security setting control module 42 makes security settings according to the environment determined by the environment determination module 40. Information about a number of security setting levels are stored in security setting information storage 44 implemented by data stored in the HDD 18. The security setting control module 42 refers to this information to make security settings according to the environment.

The power management setting control module 43 controls the operating speed of the CPU 11 and the display of the monitor 13 and also controls switching to suspend mode or hibernation mode, according to the environment of the PC 10.

Examples of the environment of the PC 10 will be described below.

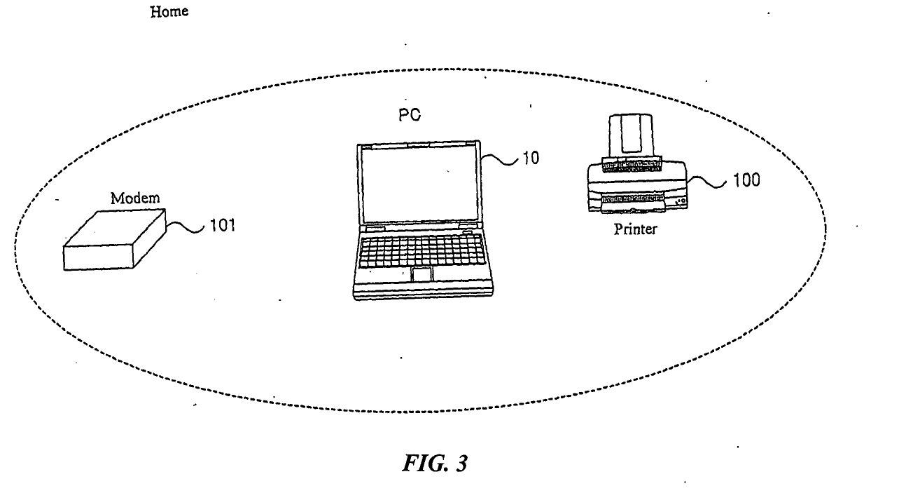

FIG. 3 shows an environment for which a security level, called “home” in the present embodiment, is set as will be described later, when the user uses the PC 10 at home.

Other Bluetooth-capable devices, which are a printer 100 and a modem 101, are within the range the Bluetooth radio wave from the PC 10 reaches when the user uses the PC 10 at home.

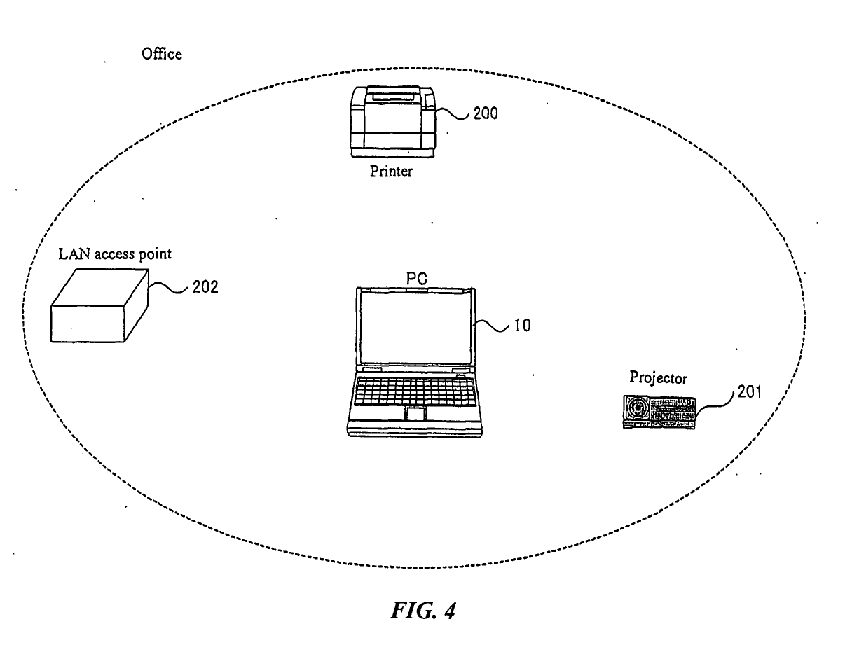

FIG. 4 shows an environment for which a security level, called “office” in the present embodiment, is set as will be described later when the user uses the PC 10 at his or her office.

When the user uses the PC 10 in his or her office, other Bluetooth-capable devices, which are a printer 200, a projector 201, and a LAN access point 202 for accessing the network 50, are within the range the Bluetooth radio wave from the PC 10 reaches.

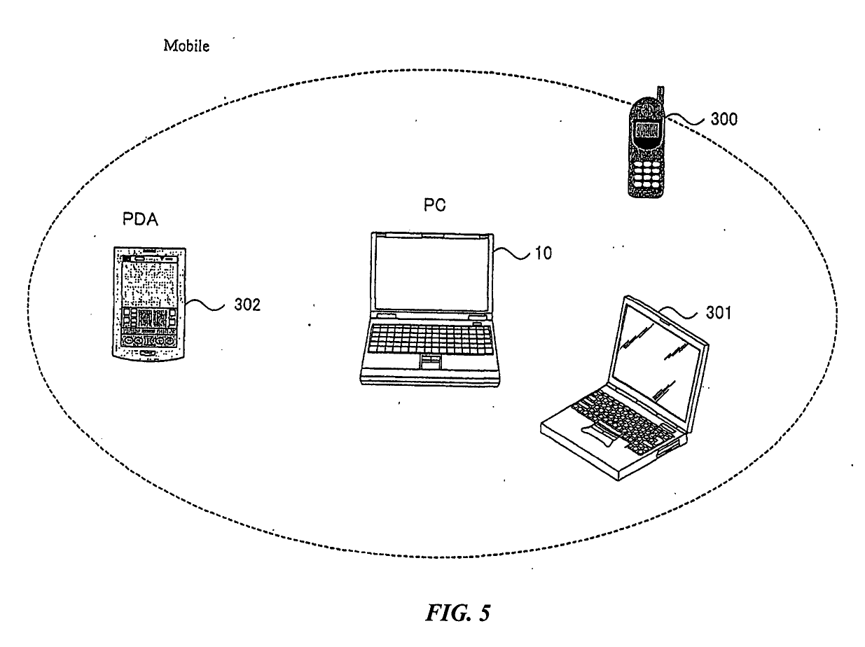

FIG. 5 shows an environment for which a security level called “mobile” in the present embodiment is set as will be described later when the user uses the PC 10 on the go.

The following is assumed here. The user has no other Bluetooth-capable devices for his or her own use within the range the Bluetooth radio wave reaches when the user uses the PC 10 on the go. A Bluetooth-capable cellphone 300, PC 301 (which may or may not has the same configuration as that of the PC 10), PDA 302, and other devices owned by other people may exist within the range the Bluetooth radio wave from the PC 10 reaches on a train, in business quarters, or a coffee shop, or any other place.

Examples of these security levels, “home,” “office,” “mobile,” will be described below.

There are three items of security settings, “Authentication,” “Authorization,” and “Encryption,” for Bluetooth communication.

The “authentication” is a mutual authentication between devices communicating through Bluetooth by means of a keyword called a passkey, which is manually input, or a link key, which is a keyword generated automatically on the basis of the passkey.

The “authorization” is a process that is performed each time a service such as file transfer or business-card exchange is performed for controlling whether or not access should be permitted.

The “encryption” is a process that is performed when data is transmitted between devices for encrypting data by means of an encryption key generated from a link key.

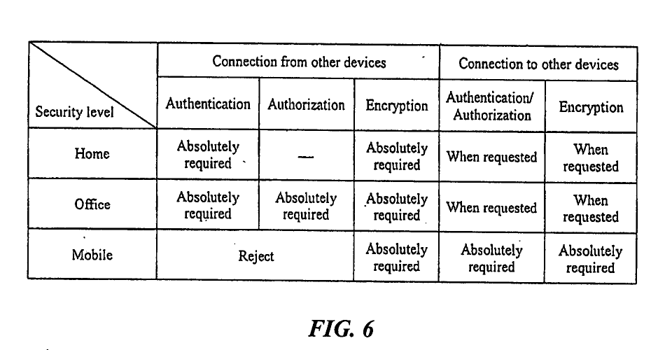

FIG. 6 shows exemplary security level settings. The level of security, from highest to lowest, is “home”<“office”<“mobile”. The degree of difficulty of access from the PC 10 to an external resource and access from an external resource to the PC 10 becomes more difficult in that order. That is, access control in the PC 10 becomes tighter in that order.

If the security level “home” is set, “authentication” of a device should absolutely be performed, “authorization” may be performed depending on circumstances, and “encryption” of data should absolutely be performed, before the device can connect to the PC 10. When the PC 10 connects to a device, “authentication” of the device, “authorization”, and “encryption” are performed if requested by that device.

If the security level “office” is set, “authentication” and “authorization” of the device, and “encryption” of data should absolutely be performed before a device can connect to the PC 10, because highly confidential business data may be exchanged. When the PC 10 connects to a device, “authentication” of the device, “authorization,” and “encryption” will be performed if requested by the device.

If the security level “mobile” is set, access from any devices owned by others is always “rejected” because the highest security must be ensured on the go. When the PC 10 connects to a device, “authentication” of the device, “authorization,” and “encryption” are absolutely required.

Security levels as shown in FIG. 6 may be set by the user selecting from settings beforehand or a number of security levels as shown may be provided by default.

The user must select and set one of the security levels described above according to the environment in which he or she uses the PC 10.

For that purpose, the user activates an application for setting security for the environment.

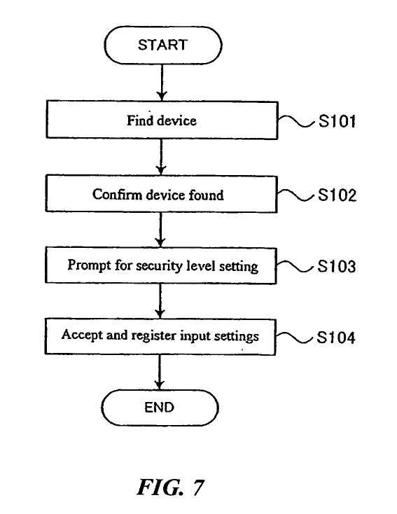

As shown in FIG. 7, the application then causes the Bluetooth communication controller 30 in the PC 10 to search for devices in the range the Bluetooth radio wave reaches (step S101). If Bluetooth-capable devices are found in the range, the BD addresses of the devices can be detected (captured). The BD addresses provide the identification information, device information, and address information about the devices.

The PC 10 captures the BD addresses emitted from the devices to confirm the devices in the vicinity of the PC 10 (step S102).

The PC 10 then can display on the monitor 13 information about the devices whose the BD addresses it captured to prompt the user to check them. Thus, the user can select one of devices to which power is continuously supplied from among the devices just captured.

The PC 10 then displays on the monitor 13 a message to prompt the user to set a security level for the PC 10 for the current place (step S103).

The user selects and enters a security level for that place (environment) from among a number of levels as shown in FIG. 6.

The PC 10 accepts the selected and entered security level and associates and stores it with the BD address of the detected device in storage such as the HDD 18 to register the security level setting (step S104).

In an environment where the BD addresses of a printer 100 and a modem 101 are detected as shown in FIG. 3, for example, the security level “home” selected by the user is registered. In an environment where a printer 200, a projector 201, and a LAN access point 202 are detected, the security level “office” selected by the user is associated with the BD address and registered as shown in FIG. 4.

The security setting process accomplished through the series of steps shown in FIG. 7 is required to be performed only at places, such as the user's “home” or “office”, where the user visits very frequently.

At other places, the security level “mobile” may be set by the user or by default.

In the process described above, settings for performing communication over the network 50 in each environment and settings for the printers 100 and 200 may be stored in the PC 10. For example, settings for using the modem 101 in the example shown in FIG. 3 and settings for using the LAN access point 202 in the example shown in FIG. 4 may be stored.

Furthermore, a power management setting for each environment may be made in the process described above. For example, in an environment for which the security level “mobile” is set, the processing speed of the CPU 11 and the rotation speed of the HDD 18 may be reduced or power supply to those components which are used only for controlling the AC adapter, not used while the PC 10 is being carried around, may be shut off in order to reduce power consumption.

Once the security setting for the environments has been made, the PC 10 automatically performs the following process to select a security setting for the environment in which the PC 10 is used.

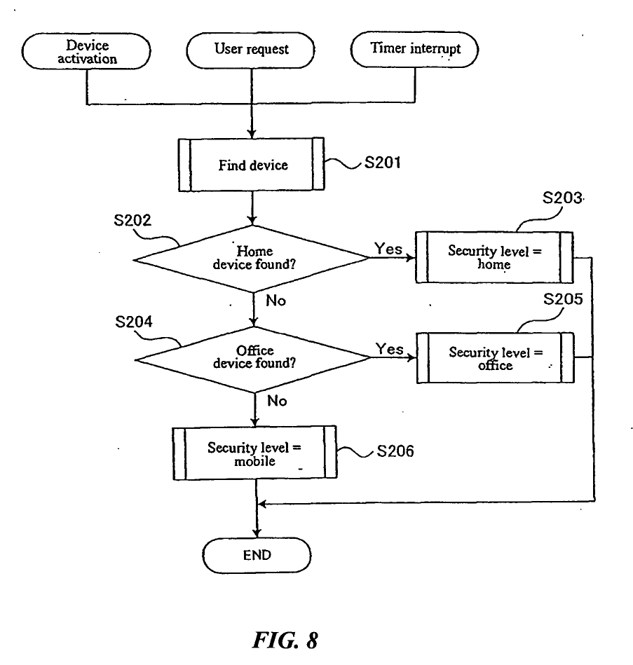

As shown in FIG. 8, after the PC 10 system is activated, a request is issued by the user through a predetermined operation, or a preset timer interrupt occurs, then the Bluetooth communication controller 30 in the PC 10 searches for devices within the range the Bluetooth radio wave from the PC 10 reaches (step S201). Then, the BD addresses of devices within the range can be captured.

Then, the environment determination module 40 in the PC 10 determines the environment of the PC 10 at the time on the basis of the BD addresses captured.

For that purpose, the environment determination module 40 determines whether or not BD addresses associated with the security level “home” are included among the BD addresses detected. In other words, the determination module 40 determines whether or not there exist devices that would be found in the environment for which the security level “home” should be set (step S202).

If any of the BD addresses associated with the security level “home” are included among the BD addresses detected, the environment determination module 40 determines that the PC 10 is in an environment for which the security level “home” should be set. Then, the security setting control module 42 switches the security level setting used in Bluetooth communication through the Bluetooth communication controller 30 of the PC 10 to the security level “home” (step S203). In addition, the communication setting control module 41 may change settings on the PC 10 for communication over the network 50 to settings for a device (the modem 101 in the example in FIG. 3) whose BD address has been detected. Furthermore, it may automatically change printer settings on the PC 10 to settings for a device (the printer 100 in the example in FIG. 3) whose BD address has been detected.

On the other hand, if any of the BD addresses associated with the security level “home” are not included among the BD addresses detected, the environment determination module 40 determines whether or not BD addresses associated with the security level “office” are included among the BD addresses detected. That is, the determination module 40 determines whether or not there exist devices that would be found in the environment for which the security level “office” should be set (step S204).

If any of the BD addresses associated with the security level “office” are included among the BD addresses detected, then the environment determination module 40 determines that the PC 10 is in an environment for which the security level “office” should be set. Then, the security setting control module 42 switches the security level setting used in Bluetooth communication performed by the Bluetooth communication controller 30 of the PC 10 to the security level “office” (step S205). In addition, the communication setting control module 41 may change settings on the PC 10 for communication over the network 50 to settings for a device (the access point 202 in the example in FIG. 4) whose BD address has been detected. Furthermore, it may automatically change printer and projector settings on the PC 10 to settings for devices (the printer 200 and the projector 201 in the example in FIG. 4) whose BD addresses have been detected.

On the other hand, if the BD addresses associated with the security level “office” are not included among the BD addresses detected, the environment determination module 40 determines that the PC 10 is in an environment for which the security level “mobile” should be set. Then, the security setting controller 42 switches the security level setting used in Bluetooth communication performed by the Bluetooth communication controller 30 of the PC 10 to the security level “mobile” (step S206). In addition, the power management control module 43 may switches to the highest power management level setting.

According to the arrangement described above, the PC 10 can use Bluetooth to search for devices in the vicinity of it to determine the environment in which the PC 10 is used and automatically change the security level setting according to the environment. This can ensure that security level changes are made according to environments in which the PC 10 is used and thereby ensure that always an optimum security environment is provided. Moreover, the usability of the PC 10 is improved because the need is eliminated for the user to change security settings each time the PC 10 is used in a different environment.

Furthermore, if the PC is in an environment for which the security level “home” or “office” should be set but devices that would be found in that environment cannot be detected in the process for determining the environment because of the conditions of wireless communication or others, the highest security level, “mobile,” is set. This provides a fail-safe function.

In addition, settings for network communication, power management, printers, projectors and other devices can be automatically changed according to the environment determined. This also can significantly improve the usability of the PC 10.

Moreover, Bluetooth is used in making these settings. Bluetooth does not require that the PC 10 send information about itself to other deices in an environment for which security level “mobile” should be set because it does not require data communication between the PC 10 and the devices as long as they are supplied with power. Thus, the advantages described above can be provided with a high level of security being ensured.

The security levels shown in FIG. 6 are provided by way of example only. Two levels, or more than three levels of security may be set. Furthermore, the security level categories, “home,” “office,” and “mobile” can be changed as appropriate.

Moreover, the same security level “office” can be set for a number of environments such as the user's desk at office and a meeting room used by the user, for example. In that case, settings for communication and power management for each of the environments can be stored in the PC 10 so that the settings can be automatically changed according to the environments.

While Bluetooth and BD addresses uniquely assigned to devices are used to identify an environment in the embodiment described above, the present invention is not limited to this arrangement.

IP addresses that the PC 10 exchanges with other devices in data communication, base station addresses used in a wireless or cellphone network, or MAC addresses may be used. When IP addresses or MAC addresses are used, devices in the vicinity of the PC 10 are identified to determine the environment in a manner similar to that described above. When base station addresses used in a wireless or cellphone network are captured, a base station is identified in effect to determine the position in which the PC 10 is used. Then, security settings suitable to the environment are established.

IP addresses can be used to pinpoint a particular area such as a particular floor of an office building to determine the environment of the PC 10 even if the addresses are dynamically allocated. Preferably, besides an address used for general purposes, a unique IP address should be set for the purpose of identifying environments.

For the purpose of identifying the place in which the PC 10 is used by the use of a base station address, the Global Positioning System may be used to measure the position of the PC 10 to determine the environment in which it is used.

A program for automatically changing security settings according to environments as described with respect to the present embodiment may be embodied on a storage medium as below.

The program to be executed by a computer apparatus may be stored on a storage medium such as a CD-ROM, DVD, memory, or hard disk in a computer-readable manner.

Various other modifications and substitutions may be made to the configuration and arrangements that has been described above with respect to the present embodiment without departing from the spirit and scope of the present invention.

According to the present invention, setting changes can be reliably made according to environments and a high-security network-connection environment can be always ensured, as described above.

In the drawings and specifications there has been set forth a preferred embodiment of the invention and, although specific terms are used, the description thus given uses terminology in a generic and descriptive sense only and not for purposes of limitation.

What is claimed is:

1. Apparatus comprising:
a communication controller which acquires identification information of an other device by communicating with the other device;
an environment module which determines the environment under which the computer apparatus is located based on the acquired identification information; and
a control module which selects a setting of the computer apparatus based on the determined environment.

2. Apparatus of claim 1, wherein the environment module determines the environment by identifying the other device existing in periphery of the computer apparatus based on the identification information.

3. Apparatus of claim 2, wherein the communication controller acquires a Bluetooth device address as the identification information from the other device being capable of Bluetooth communication.

4. Apparatus of claim 1, wherein the control module selects a security setting of the computer apparatus based on the determined environment.

5. Apparatus of claim 4, wherein the control module:
selects a security setting corresponding to the determined environment if the environment is a prescribed environment; and
selects a security setting with a security level higher than that for the prescribed environment if the determined environment is not the prescribed environment.

6. Apparatus of claim 1, wherein the control module selects a setting for controlling power consumption in the computer apparatus according to the determined environment.

7. A method comprising:
acquiring information about an environment in which a computer is located; and
selecting a security setting of the computer on the basis of the acquired information.

8. The method of claim 7, wherein the acquisition comprises acquiring identification information about a device in the vicinity of the computer, the identification information being transferred from the device.

9. The method of claim 8, wherein the selection comprises selecting the level of the security setting according to whether the identification information about the device is registered beforehand.

10. The method of claim 9, wherein if the identification information about the device is not registered, the level of the security setting is changed to a level higher than a current level.

11. A method comprising:
acquiring device information about a device capable of communicating with a computer apparatus;
receiving a security setting specified for an environment in which the device information can be acquired; and
associating and storing the specified security setting with the device information.

12. The method according to claim 11, wherein, after storing the security setting and the device information, the computer apparatus further performs acts which include:
acquiring device information about a device ready to communicate with the computer apparatus;
invoking the security setting associated with the obtained device information; and
changing the current security setting on the computer apparatus to the invoked security setting.

13. A product comprising:
a computer usable medium having computer readable program code stored therein for causing a computer apparatus to perform a predetermined process, the computer readable program code in said product being effective to:
acquire address information about a device found in the vicinity of the computer apparatus through Bluetooth-based communication with the device; and
select settings on the computer apparatus on the basis of the acquired address information.

14. The product of claim 13, wherein the selection comprises a change to a security setting on the computer apparatus.

15. The product of claim 14, wherein the selection comprises a change to the level of the security setting according to whether the address information is registered beforehand.

16. The product of claim 15, wherein the change comprises a change to the level of the security setting to a higher level if the address information about the device is not registered beforehand.
